(19) United States
(12) Patent Application Publication
(10) Pub. No.: US 2010/0055802 A1
(43) Pub. Date: Mar. 4, 2010

(54) Analysis using separation combined with chemical conversion followed by optical spectroscopy

(76) Inventors: Richard N. Zare, Stanford, CA (US); Eric R. Crosson, Mountain View, CA (US); Bruce A. Richman, Sunnyvale, CA (US); Nabil M.R. Saad, Menlo Park, CA (US)

Correspondence Address: LUMEN PATENT FIRM, 350 Cambridge Avenue, Suite 100, PALO ALTO, CA, 94306, US

(21) Appl. No.: 12/584,345

(22) Filed: Sep. 2, 2009

Related U.S. Application Data
(60) Provisional application No. 61/190,987, filed on Sep. 3, 2008.

(51) Int. Cl. G01N 21/75; G01N 21/00; G01N 30/74; G01N 27/26

(52) U.S. Cl. 436/158; 422/82.05; 422/83; 422/89; 422/70; 204/601; 204/606; 422/80; 436/164; 436/161; 204/451; 204/456

(57) ABSTRACT

The present invention relates to the separation, quantitative measurement, and analysis of trace species using a combination of three steps in succession. First, trace species are separated from other species that are present. Second, the trace species are chemically modified to convert them into specific species that are advantageous for the third and final step. In this last step, cavity enhanced optical detection of the converted species is performed to detect and measure the concentrations of the species of interest. Because the last step has spectroscopic resolution, the concentration of isotopologues in each converted species can be determined. Further processing can provide the ratios between pairs of isotopologues, in particular the ratio of the rare isotopologues to the most abundant isotopologue.

### CROSS REFERENCE TO RELATED APPLICATIONS

This application claims the benefit of U.S. provisional patent application 61/190,987, filed on Sep. 3, 2008, entitled “Combined Gas Chromatography—Chemical Conversion—Cavity Enhanced Absorption Spectroscopy”, and hereby incorporated by reference in its entirety.

### FIELD OF THE INVENTION

This invention relates to chemical analysis.

### BACKGROUND

Measurements of the isotopic ratios or trace concentration levels of analytes separable by chromatographic apparatus, such as gas chromatography (GC) or liquid chromatography (LC), have important applications in environmental monitoring, biomedical diagnostics, and other industrial, medical, and research fields of interest. Distinguishing differences in isotope ratios of carbon, hydrogen, nitrogen, oxygen and sulfur is used as a tool in evaluating gas, liquid, and solid samples related to areas such as metabolic process research, the characterization and classification of naturally occurring substances such as natural gas and oil, and kinetic processes, among many others. A number of techniques are currently used to evaluate the chemical and isotopic composition of such samples. These methods include:

1) Gas chromatography-mass spectrometry (GC-MS);
2) Gas chromatography-combustion-mass spectrometry (GC-C-MS);
3) Gas chromatography-combustion/oxidation-isotopic ratio mass spectrometry (GC-C-IRMS) (e.g., as described in U.S. Pat. No. 5,783,741); and
4) Liquid Chromatography-combustion-isotopic ratio mass spectrometry (LC-C-IRMS).

All these commonly used compound-specific isotope analysis techniques involve mass spectrometers in one form or another. A mass spectrometer separates charged molecules based on their mass-to-charge ratio. However, mass spectrometers have significant limitations, particularly when a field application or an operation by an average-skilled operator is required. Mass spectrometers must typically be kept in a laboratory, not a field setting, and their operation is complicated owing to the laborious requirements of maintaining instrument performance. In addition, they need to be closely monitored by a skilled individual to maintain reliability and high precision. As such, they are very cumbersome and poorly suited to real-time measurements in the field.

The limitations of using a mass spectrometer and isotopic ratio mass spectrometry include:

1) The mass spectrometer cannot distinguish analytes of essentially identical molecular weight (isobars).
2) The mass spectrometer often requires frequent calibration which often precludes continuous measurements without the presence of an operator.
3) The mass spectrometer is expensive and requires skilled personnel to operate.

Chemical analysis based on optical spectroscopy is an alternative approach that has been investigated for isotopic analysis and/or trace detection. Such approaches often make use of a resonant optical cavity in order to improve performance (e.g., by increasing measurement sensitivity). For example, one such technique is known as cavity ring-down spectroscopy (CRDS). Early references describing examples of CRDS include U.S. Pat. No. 5,528,040 and U.S. Pat. No. 5,912,740.

When a cavity is used to enhance optical spectroscopy, the mirrors in the optical cavity must be highly reflective (e.g., R>99.99%) to maximize sensitivity. However, mirror coatings usually cannot be designed to provide sufficiently high reflectivity at all wavelengths of interest. Thus instrument operation is typically restricted to a limited wavelength range, thereby severely reducing the number of different species that can be detected by any one instrument (i.e., the instrument versatility can be low). Moreover, complex organic molecules, which are often found in the presence of water vapor, usually have overlapping spectral features (with each other and/or with the water vapor), which can make their detection in a mixture at certain interfering wavelengths problematic.

Accordingly, it would be an advance in the art to provide a field deployable, inexpensive, easy to use, and versatile alternative to mass spectrometry that is able to distinguish analytes of identical molecular weight. Such an instrument would expand the realm of applications and conditions under which isotopic ratio and/or trace concentration level measurements of separable analytes can be performed.

### SUMMARY

The present invention relates to the separation, quantitative measurement, and analysis of trace species using a combination of three steps in succession. First, trace species are separated from other species that are present. Second, the trace species are chemically modified to convert them into specific species that are advantageous for the third and final step. In this last step, cavity enhanced optical detection (CEOD) of the converted species is performed to detect and measure the concentrations of the species of interest. Because the last step has spectroscopic resolution, the concentration of isotopologues in each converted species can be determined. Further processing can provide the ratios between pairs of isotopologues, in particular the ratio of the rare isotopologues to the most abundant isotopologue.

The present approach provides several significant advantages.

1) The use of cavity enhanced optical detection provides high sensitivity combined with spectroscopic resolution. This enables an instrument to distinguish analytes having identical nominal molecular weight, known as isobars. For example, it can distinguish ¹³C¹⁶O₂ from ¹²C¹⁶O¹⁷O. As another example, CEOD can distinguish CO₂ from N₂O, even though the most common isotopes of these compounds both have m/z=44. A mass spectrometer is not capable of distinguishing isobars such as these examples.

2) Chemical conversion (e.g., combustion) ensures that a relatively small set of analytes are presented to the cavity enhanced optical detector. As a result, the instrument need not operate over a wide range of wavelengths. Instead, a limited wavelength range can be selected that is suitable for distinguishing the analytes provided by the chemical conversion, and then the optical cavity mirrors can be designed for maximum reflectivity over the selected wavelength range. In this manner, the lack of versatility of conventional cavity-based optical spectroscopy approaches can be alleviated.

### BRIEF DESCRIPTION OF THE DRAWINGS

FIG. 1 shows a first embodiment of the invention.

FIG. 2 shows a second embodiment of the invention.

FIG. 3 shows a third embodiment of the invention.

FIG. 4 shows experimental results obtained from the embodiment of FIG. 3.

### DETAILED DESCRIPTION

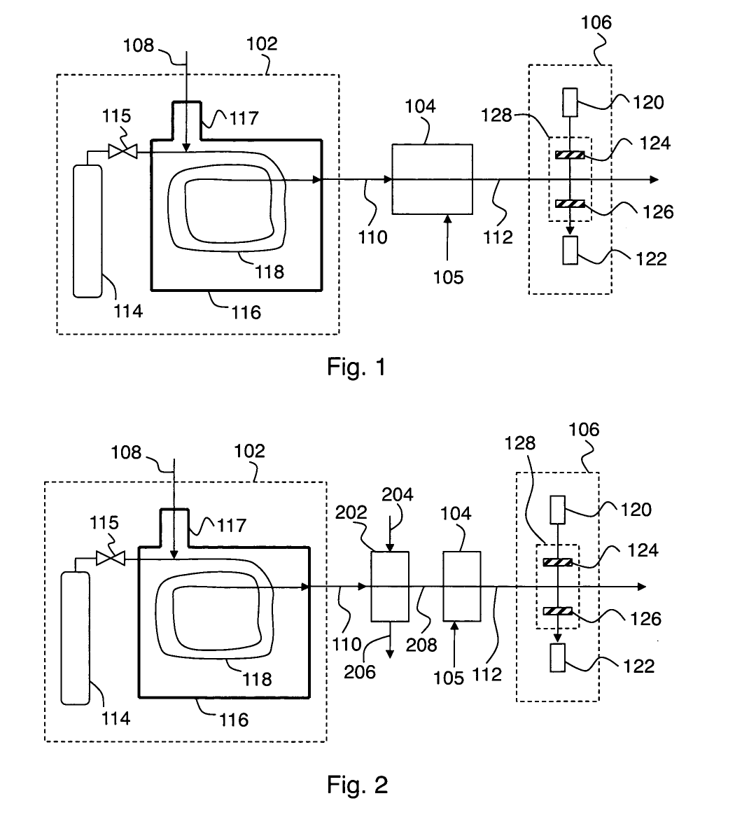

A first embodiment of the invention is shown in FIG. 1. A separator 102 provides separation of an input sample 108 into separate input components 110 according to properties of the input components. A chemical reactor 104 receives the separate input components 110 and provides one or more corresponding analyte components 112, where the analyte components are reaction products of reactions involving the corresponding input components. A CEOD instrument 106 receives the analyte components 112, and provides analysis outputs.

In a preferred embodiment, chromatography is employed as the separation technique, although the invention can be practiced using any method of separating a mixture into two or more individual components. Suitable techniques include, but are not limited to: gel or capillary electrophoresis; centrifuge; solubility (variety of solvents); biological binding; and supercritical fluid chromatography. The separated components differ in chemical, electrical, geometrical and/or physical properties. For example, in chromatography, components are separated according to their interaction with a stationary phase to produce bands of separated species in a carrier fluid, such as helium, nitrogen, or aqueous/organic liquid mobile phase.

As another example of separation according to some embodiments of the invention, the separator can include molecular binding sites for specific biological macro-molecules. By controlling the binding and release of such macro-molecules at the binding sites (e.g., by varying the pH of a solution), a separation of biological macro-molecules can be provided. Such methods for providing separation of biological macro-molecules are well known in the art.

In the example of FIG. 1, a sample is vaporized (if not already in the gas phase) and injected into the head of the chromatographic column 118 at input port 117. The sample is transported through a capillary column 118 by the flow of an inert, gaseous mobile phase provided from source 114 and having flow controlled by controller 115. Molecules are partitioned between the carrier gas (the mobile phase) and the column bonded phase (the stationary phase) within the capillary chromatography column. It is within column 118 that separation of the analytes takes place depending on the temperature of oven 116 (which provides temperature control of column 118). The retention times are based on the adsorption-desorption kinetics of the analyte with the column and the oven temperature profile used (isothermal or programmed).

Alternatively in the example of FIG. 1, the gas chromatograph can be replaced by a liquid chromatograph. This approach may be preferred in situations where large organic molecules need to be separated. In this variation, a sample is injected into the head of chromatographic column 118 at input port 117. The sample is transported through column 118 by the flow of a liquid mobile phase provided from source 114 and having flow controlled by controller 115. Molecules are partitioned between the mobile phase and the column stationary phase of a specific chemistry. It is within the column that separation of the analytes takes place depending on the mobile phase hydrophilicity to hydrophobicity ratio. The retention times are based on the partition of the analyte between the column stationary phase and the mobile phase composition used (isocratic vs. gradient).

After moving through the chromatography column, separate input components 110 are delivered to chemical converter 104. Ideally, different components of the sample will reach the reactor 104 (and cavity-enhanced instrument 106) at different times arising from the chromatography column temperature method used and the differences in partitioning between the column mobile and stationary phases. Each input component is converted into a reaction product that can be readily detected by CEOD instrument 106. Any chemical conversion approach that performs this function is suitable for practicing the invention. In a preferred embodiment, chemical converter 104 is a combustion/oxidation reactor. However, a combustion/reduction reactor or a pyrolysis furnace can be used as well. Here pyrolysis is regarded as a chemical reaction because pyrolysis entails production of fragments that are chemically different from the input reactant(s) when heat is provided. Thus, the term “reaction products” as used herein includes both products of chemical reactions and fragments resulting from pyrolysis.

Organic trace species can be converted to NOₓ, SOₓ, carbon dioxide (CO₂), water (H₂O), nitrogen oxide (N₂O), and sulfur dioxide (SO₂), among others by oxidizing the trace species. This step can be accomplished using a catalytic converter, wet oxidation, or by running an oxygen plasma discharge. In cases where separation is done using liquid chromatography and oxidation is employed, it is preferred for chemical reactor 104 to be a wet combustion/oxidizer.

In a preferred embodiment, reactor 104 is a continuous flow oxidation reactor using O₂ gas as a reactant. Although this kind of configuration is convenient in practice, it often cannot be done in connection with mass spectrometry. The reason is that O₂ cannot be provided as an input to a mass spectrometer if it is equipped with an electron impact ionization source (which is often the case in practice). If oxidation is performed in connection with mass spectrometry, a static oxidizer (e.g., CuO) is typically used, which has the disadvantage that periodic recharging of the oxidizer is needed. Accordingly, the ability to employ a continuous flow oxidation reactor is a substantial advantage of the present approach. More generally, reactor 104 can be any kind of continuous flow chemical reactor.

In a preferred embodiment, reactor 104 has an optional input 105 to allow for the introduction of reactants to reactor 104 that are not present (or are insufficiently present) in the output of separator 102. For example, in a gas chromatographic separation using helium as a carrier gas, oxygen can be provided to reactor 104 via input 105.

In the example of FIG. 1, cavity enhanced optical detection (CEOD) instrument 106 includes an optical cavity 128 formed by mirrors 124 and 126, an optical source 120, and an optical detector 122. Cavity enhanced optical detection entails the use of a passive optical resonator, also referred to as a cavity, to improve the performance of an optical detector. As used herein, CEOD refers to any spectroscopic technique where an optical cavity is employed to enhance an optical spectroscopy signal. Cavity enhanced absorption spectroscopy (CEAS) is a broad sub-category of CEOD which uses optical absorption to provide the spectroscopy signal. Integrated cavity output spectroscopy (ICOS) and cavity ring down spectroscopy (CRDS) are among the most widely used CEAS techniques. CEOD also includes techniques that do not rely on absorption spectroscopy. For example, cavity enhanced magnetic rotation spectroscopy (also known as cavity enhanced Faraday rotation spectroscopy) is a type of CEOD which depends on the change of optical polarization by the species of interest instead of optical absorption.

In CEOD techniques, the optical resonator includes two or more mirrors in an optical cavity aligned so that incident light circulates between them. Mirrors include reflective materials, such as metal or dielectric multi-layer coatings deposited on a substrate such as glass or fused silica, prisms utilizing total internal reflection, refractive optical elements, or any other optical element which redirects an optical beam. The sample of absorbing material is placed in the cavity for interrogation. The output of a CEOD instrument is typically a cavity ring-down time, from which quantities of interest such as analyte concentrations and/or ratios can be inferred.

The optical cavity is the primary component of a CEOD apparatus. It consists of at least two mirrors of high reflectivity. A light source, such as a laser, provides optical excitation to the cavity. A detector measures the light transmitted through the cavity. The light source can be either broadband or narrowband. If it is broadband, then typically, the transmitted light is dispersed or filtered so that only a narrow band is incident on the detector at any time. The dispersion or filter is often tunable so as to acquire a complete optical spectrum. If the laser is narrowband, it is often tunable to acquire a complete optical spectrum. If a narrowband laser is used, an optional wavelength meter provides an accurate measure of the light frequency (equivalently the wavelength).

In the case of CRDS, light intermittently fills the cavity. When the intensity of light circulating in the cavity reaches a threshold, the light is made so that it no longer fills the cavity: it is turned off, steered away, or its optical frequency is shifted away from cavity resonance. Usually, it is desirable to excite a single transverse spatial mode of the cavity. The intensity of single-mode radiation trapped within the optical resonator decays exponentially over time (after the exciting light source has been made not to fill the cavity), with a time constant τ, which is often referred to as the ring-down time. A detector typically is positioned to receive a portion of the radiation leaking from the resonator, so the detector signal also decays in time exponentially with time constant τ. The time-dependent signal from this detector is processed to determine τ (e.g., by sampling the detector signal and applying a suitable curve-fitting method to a decaying portion of the sampled signal). Note that CRDS entails an absolute measurement of τ. Both pulsed and continuous wave laser radiation can be used in CRDS with a variety of factors influencing the choice.

The ring-down time τ depends on the cavity round trip length and on the total round-trip optical loss within the cavity, including loss due to absorption and/or scattering by one or more target analytes within a sample positioned inside the cavity. Thus, measurement of the ring-down time of an optical resonator containing a target analyte provides spectroscopic information on the target species. Both CRDS and CEAS/ICOS are based on such a measurement of τ. Off-axis ICOS eliminates the resonances of the optical cavity but still preserves its sensitivity-amplifying properties.

Single spatial mode excitation of the resonator is also usually employed in CEAS (ICOS) but ICOS differs from CRDS in that the wavelength of the source is swept (i.e., varied over time), so that the source wavelength coincides briefly with the resonant wavelengths of a succession of resonator modes. Off-axis ICOS (OA-ICOS) is similar in that the wavelength is swept, except that multiple transverse modes are intentionally excited in order to provide a greater density of mode frequencies. In ICOS, and OA-ICOS, the signal from the detector is integrated for a time comparable to the time it takes the source wavelength to scan across a resonator mode of interest. The resulting detector signal is proportional to τ so the variation of this signal with source wavelength provides spectral information on the sample. Note that ICOS entails a relative measurement of τ.

In cavity enhanced optical detection, the measured ring-down time depends on the total round trip loss within the optical resonator. Absorption and/or scattering by target analytes within the cavity normally account for the major portion of the total round trip loss, while parasitic loss (e.g., mirror losses and reflections from intracavity interfaces) accounts for the remainder of the total round trip loss. The sensitivity of cavity enhanced optical detection improves as the parasitic loss is decreased, since the total round trip loss depends more sensitively on the target species concentration as the parasitic loss is decreased. Accordingly, both the use of mirrors with very low loss (i.e., a reflectivity greater than 99.99 percent), and the minimization of intracavity interface reflections are important for cavity enhanced optical detection. Although the present invention will be described primarily in the context of CRDS, it is also applicable in connection with any kind of cavity enhanced optical detection, including but not limited to CEAS, ICOS, and CRDS. CRDS has the advantage that it is insensitive to power variations of the source radiation used.

Analyte components 112 are admitted to cavity enhanced optical detector 106. CEOD 106 then measures the quantity or isotopic composition of the output products (i.e., analyte components 112) of reactor 106. For example, CEOD instrument 106 could measure the quantities of multiple isotopologues of at least one of CO₂, H₂O, NOₓ, SOₓ, etc., in a system where organic input components are oxidized. In a preferred embodiment, CEOD instrument 106 is a cavity ring-down spectroscopy apparatus. State of the art CRDS instruments can quite sensitively measure the ratio of ¹³C¹⁶O₂ to that of ¹²C¹⁶O₂, and the ratios of DH¹⁶O to H₂¹⁶O and H₂¹⁸O to H₂¹⁶O, thereby obtaining the ¹³C to ¹²C ratio, D to H ratio and ¹⁸O to ¹⁶O ratio, respectively, of oxidation products of trace organic species.

Significant advantages follow from the use of optical spectroscopy. Optical spectroscopy can distinguish isobars (i.e., analytes of identical nominal molecular weight). For example, it can distinguish ¹³C¹⁶O₂ from ¹²C¹⁶O¹⁷O. CEOD techniques provide sensitivity competitive with mass spectrometry. CEOD permits the use of very small samples with little or no sample preparation. CEOD devices are smaller and lighter than mass spectrometers and as a result are more portable. Properly engineered CEOD instruments can operate continuously for long periods of time without human intervention. In addition, CEOD devices can be designed to measure multiple analytes.

FIG. 2 shows a second embodiment of the invention. This embodiment is similar to the embodiment of FIG. 1, except that analyte conditioner 202 is disposed between separator 102 and reactor 104. Conditioner 202 can perform various functions. For example, in connection with separation by liquid chromatography, conditioner 202 can be configured as an extended trap to remove the liquid carrier content (e.g. water or organic solvent) from analyte components 110, before passing conditioned analyte components 208 to reactor 104. The trapped carrier can exit the system via outlet 206. As another example, if the output flow rate from reactor 104 is less than a desired input flow rate to instrument 106, an inert carrier gas can be provided via inlet 204 to match the flow rates. In this second example, conditioner 202 would be disposed between reactor 104 and CEOD instrument 106. Thus, a sample conditioner can be disposed between separator 102 and reactor 104 and/or between reactor 104 and CEOD instrument 106.

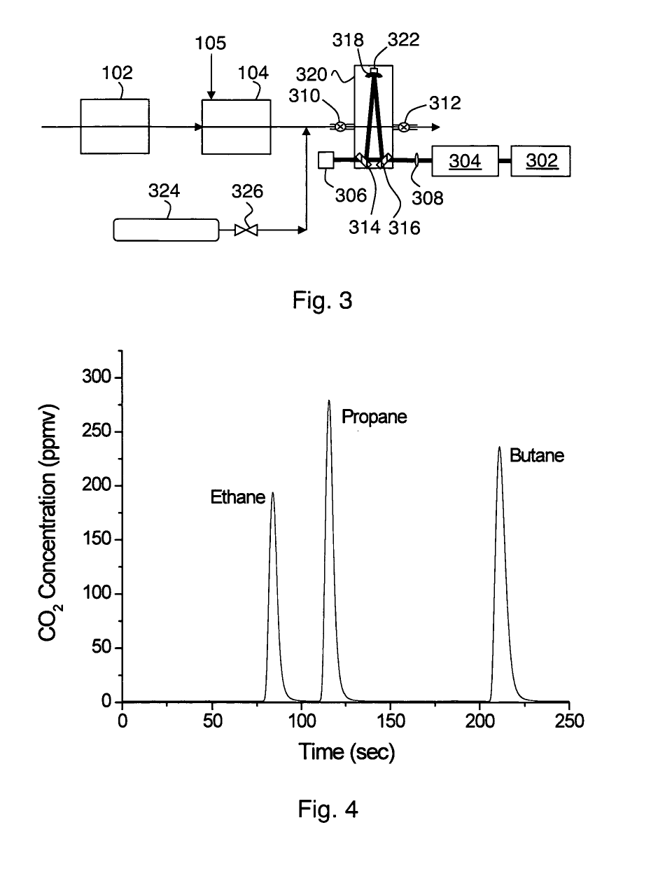

FIG. 3 is a schematic showing an embodiment of a gas chromatograph—combustion/oxidizer—CRDS apparatus which has been built and tested. Here separator 102 is a gas chromatograph, reactor 104 is a catalytic converter acting as a combustion/oxidizer device, and CRDS detection is employed. In the CRDS part of the instrument, a tunable laser 302 provides light which is monitored by a wavelength monitor 304. A cavity assembly 320 includes mirrors 314, 316, and 318. Thus the cavity of this example is a 3-mirror ring cavity. Focusing optics 308 is employed to couple and mode-match light from laser 302 into the cavity. Sample flow through the detector is controlled by sample inlet 310 and sample outlet 312. The cavity length is altered by transducer 322 in order to sweep the cavity resonance past the laser wavelength, thereby generating ring-down signals at detector 306.

A sample, consisting of a mixture of ethane, propane, and butane, was injected at the head of the chromatographic column. The sample was transported through the column by a flow of helium acting as a carrier gas. The ethane, propane, and butane, in helium carrier gas were separated in time within the GC column. The time separated ethane, propane, and butane in helium carrier gas was transported via metal tubing to the catalytic converter. Oxygen gas was also provided to the catalytic converter via input 105. The catalytic converter converted the separated ethane, propane, and butane into three groups of CO₂ molecules corresponding to the conversion of each component of the sample. The gas flow through the oxidizer was such that the time separation introduced by the GC was maintained throughout the oxidation process. As a result, when exiting from the catalytic converter, the three groups of CO₂ reaction products had the same time structure as that introduced by the GC.

In this experiment, the CO₂ conversion products were measured using a CRDS instrument. To match the flow characteristics of the CRDS analyzer, a constant flow of nitrogen gas was added to the CO₂, O₂ and helium mixture at the output of the oxidizer and before the input to the CRDS device. On FIG. 3, the nitrogen source is shown as 324, and its flow controller is shown as 326. This was necessary because the CRDS device used here required a gas flow approximately 8 times higher than the optimal flow rate required for good separation of the ethane, propane, and butane sample by the GC. This mixture of ethane, propane, butane, oxygen, helium, and nitrogen was connected to the CRDS device gas inlet via metal tubing. FIG. 4 is an example of the CO₂ products measured as a function of time and made by introducing an ethane, propane, and butane sample into this GC-C-CRDS device. The measurements of CO₂ were made continuously at a data rate of 4 Hz.

The preceding description has been by way of example as opposed to limitation, and practice of the invention includes many variations of the given examples. For example, this approach is applicable to numerous different trace species. One application of interest is detection and concentration measurement of organic (carbon-containing) compounds. The isotopic ratios of several elements in the chemically converted organic trace species are of interest, These include but are not limited to: carbon-13 (¹³C) to carbon-12 (¹²C) isotope-containing compounds; deuterium (2H) to hydrogen (¹H) isotope-containing compounds; oxygen-18 (¹⁸O) and oxygen-17 (¹⁷O) to oxygen-16 (¹⁶O) isotope-containing compounds; nitrogen-15 (¹⁵N) to nitrogen-14 (¹⁴N) isotope-containing compounds; and sulfur-34 (³⁴S) to sulfur-32 (³²S) isotope-containing compounds. This invention is not limited to this purpose but has the potential for many different applications.

Simultaneous measurements of analyte quantities and/or isotopic ratios can be performed, either with parallel instruments or within a single instrument. Whether to use a single instrument or parallel instruments is primarily determined by the limited wavelength bandwidth of the cavity mirrors of a single instrument and the proximity of optical absorption features of the various analytes to be quantified. Analytes whose absorption features all occur within the wavelength bandwidth of a single type of cavity may be detected with a single instrument. Detection of a set of analytes whose absorption features occur only within the bandwidths of different cavities require multiple parallel instruments.

For example, the measurement of the isotopic ratios of ¹⁸O to ¹⁶O (e.g. H₂¹⁸O to H₂¹⁶O) and ²H to ¹H (e.g. ²H¹H¹⁶O₂ to ¹H₂¹⁶O₂) can be accomplished with a single instrument using a cavity with a wavelength bandwidth including 1390-1400 nm. Whereas, measurement of isotopologues of water, carbon dioxide, and methane may require both an instrument for isotopologues of water, and another instrument for isotopologues of carbon dioxide and methane with a cavity of which the wavelength bandwidth includes 1600-1650 nm. The wavelength bandwidth of only one cavity typically will not include both ranges.

A “single instrument” as described herein has a single optical cavity and a single gas handling system, but may include multiple lasers. Such multiple lasers can be set to different absorption features within the instrument optical bandwidth (e.g., to two or more pertinent spectral lines in the 1390-1400 nm range of the first example above). Alternatively, a single CEOD instrument may provide the capability of operating at multiple wavelengths by making use of a tunable laser. Such an instrument can be regarded as providing simultaneous measurement capability if the time needed to tune from one wavelength to another wavelength is negligible compared to other relevant times (e.g., the period at which samples are measured in a periodic monitoring application).

Although the present approach is especially advantageous for isotopic analysis, it is also applicable to quantitative analysis, or to any combination of isotopic and quantitative analysis. Here isotopic analysis includes any analysis that provide information as to the isotopic composition of an analyte, and quantitative analysis includes any analysis that provides information as to the amount present and/or concentration of an analyte in a sample.

1. Apparatus for sample analysis, comprising:
a separator, wherein an input sample can be separated into separate input components according to properties of said input components;
a chemical reactor, wherein one or more of said input components chemically react to provide corresponding analyte components as reaction products, wherein said analyte components include chemical elements of said input components for which analysis is desired;
a cavity enhanced optical detection (CEOD) instrument, wherein analysis of said analyte components can be performed.

2. The apparatus of claim 1, wherein said separator comprises a gas chromatography column.

3. The apparatus of claim 1, wherein said separator comprises a liquid chromatography column.

4. The apparatus of claim 1, wherein said separator comprises a supercritical fluid chromatography column.

5. The apparatus of claim 1, wherein said separator comprises a capillary or gel electrophoresis column.

6. The apparatus of claim 1, wherein said separator comprises molecular binding sites for specific biological macro-molecules.

7. The apparatus of claim 1, wherein said reaction products comprise oxidation products of said input components.

8. The apparatus of claim 7, wherein said chemical reactor comprises a continuous flow oxidation reactor.

9. The apparatus of claim 1, wherein said reaction products comprise pyrolytic fragments of said input components.

10. The apparatus of claim 9, wherein said chemical reactor comprises a continuous flow pyrolysis furnace.

11. The apparatus of claim 1, wherein said cavity enhanced optical detector includes a cavity ringdown spectroscopy instrument.

12. The apparatus of claim 1, wherein said cavity enhanced optical detector includes an integrated cavity output spectroscopy instrument.

13. The apparatus of claim 1, wherein said analysis of said analyte components comprises isotopic analysis of said analyte components.

14. The apparatus of claim 1, wherein said analysis of said analyte components comprises quantitative analysis of said analyte components.

15. The apparatus of claim 1, wherein two or more isotopic ratios of said analyte components are determined simultaneously.

16. The apparatus of claim 1, further comprising a sample conditioner disposed between said separator and said CEOD instrument.

17. A method for sample analysis, the method comprising:
passing an input sample through a separator to provide a separation of the input sample into separate input components according to properties of said input components;
chemically reacting one or more of said input components to provide corresponding analyte components as reaction products, wherein said analyte components include chemical elements of said input components for which analysis is desired;
performing analysis of said analyte components with cavity-enhanced optical detection.

18. The method of claim 17, wherein said separator comprises a gas chromatography column.

19. The method of claim 17, wherein said separator comprises a liquid chromatography column.

20. The method of claim 17, wherein said separator comprises a supercritical fluid chromatography column.

21. The method of claim 17, wherein said separator comprises a capillary or gel electrophoresis column.

22. The method of claim 17, wherein said separator comprises molecular binding sites for specific biological macro-molecules.

23. The method of claim 17, further comprising removing a chromatography carrier liquid from said analyte components prior to said performing analysis.

24. The method of claim 17, wherein said chemically reacting comprises oxidation of said input components.

25. The method of claim 24, wherein said oxidation of said input components is performed in a continuous flow oxidation reactor.

26. The method of claim 17, wherein said reaction products comprise pyrolytic fragments of said input components.

27. The method of claim 26, wherein said chemically reacting comprises continuous flow pyrolysis.

28. The method of claim 17, wherein said cavity enhanced optical detection comprises cavity ringdown spectroscopy.

29. The method of claim 17, wherein said cavity enhanced optical detection comprises integrated cavity output spectroscopy.

30. The method of claim 17, wherein said analysis of said analyte components comprises isotopic analysis of said analyte components.

31. The method of claim 17, wherein said analysis of said analyte components comprises quantitative analysis of said analyte components.

32. The method of claim 17, wherein two or more isotopic ratios of said analyte components are determined simultaneously.

33. The method of claim 17, further comprising conditioning said separate input components prior to said chemically reacting.

34. The method of claim 17, further comprising conditioning said analyte components prior to said performing analysis.
